(19) United States
(12) Patent Application Publication
(10) Pub. No.: US 2014/0020531 A1
(43) Pub. Date: Jan. 23, 2014

(54) METHOD OF PREVENTING TOOTH FROM CONTINUOUSLY BREAKING IN BAND SAW BLADE, SAW TOOTH STRUCTURE OF BAND SAW BLADE USED FOR THE METHOD AND BAND SAW BLADE WITH TOOTH HAVING THE SAME SAW TOOTH STRUCTURE

(71) Applicant: Amada Company , Limited, Kanagawa (JP)

(72) Inventor: Susumu TSUJIMOTO, Hyogo (JP)

(73) Assignee: Amada Company , Limited, Kanagawa (JP)

(21) Appl. No.: 13/951,895

(22) Filed: Jul. 26, 2013

Related U.S. Application Data
(62) Division of application No. 09/074,459, filed on May 8, 1998, now abandoned.

(30) Foreign Application Priority Data
May 8, 1997 (JP) 9-118356

(51) Int. Cl. B23D 61/12

(52) U.S. Cl. CPC B23D 61/121
USPC 83/13

(57) ABSTRACT

A method of preventing a tooth from continuously breaking in a band saw blade, comprises the steps of: moving the band 5 saw blade to a longitudinal direction and moving the band saw blade to a cutting direction perpendicular to the moving direction of the band saw blade so as to cut a work; bringing a projecting portion disposed at a rear position of a surface of relief at the back of a tip in a saw tooth broken into contact 10 with a bottom portion of a cutting groove in the work when the tooth breaking is generated in the saw tooth of the band saw blade; and limiting a cutting amount of the following saw tooth, thereby preventing the following saw tooth from breaking.

### RELATED APPLICATIONS

This application is a divisional of U.S. patent application Ser. No. 09/074,459, filed on May 8, 1998, which claims the priority of Japan Application No. 9-118356, filed on May 8, 1997, the contents of both of which are hereby incorporated by reference.

### BACKGROUND OF THE INVENTION

1. Field of the Invention

The present invention relates to a method of preventing tooth from continuously breaking in a band saw blade, a saw tooth structure of the band saw blade used for the method and a band saw blade with a tooth having the same saw tooth more particularly to a method of preventing tooth from continuously breaking in a band saw, a saw tooth structure of the band saw blade used for the method and a band saw blade with a tooth having the same saw tooth structure.

2. Description of the Related Arts

Conventionally, in cutting the shape steel, the pipe, the sheet pile, the deck plate and the like, in order to prevent a chipping and a breaking of a tip of the band saw blade due to the great vibration generated at a time of cutting, there has been performed a design, for example, as shown in U.S. Pat. Nos. 5,018,421 and 5,501,129.

However, in U.S. Pat. No. 5,018,421, a surface of relief is formed in a circular arc shape so as to improve a tip strength against the chipping and the tooth breaking, however, in the structure mentioned above, a thrust performance is bad, so that there is a problem that it is hard to cut at a high speed.

Further, in U.S. Pat. No. 5,501,129, there is a feature that a high speed cutting can be performed by combining the structure disclosed in U.S. Pat. No. 5,018,421 with the conventional tooth and strength against the chipping and the tooth breaking can be obtained, however, when a great tooth breaking is generated due to some reasons, a great grain depth of cut is generated in the following tooth, and a great cutting resistance is generated, so that there is a problem that the tooth breaking is continuously generated one by one.

Still further, as a method to strengthen the tooth against the chipping and the tooth breaking, originally, a method of making an angle of relief and a front rake of the saw tooth small so as to make a strength of a tip great has been employed, however, when the angle of relief is particularly made small, the strength of the tip is made great. However, in this case, a cutting resistance is also increased, so that there is a contradictory problem that it is rather hard to perform a cutting.

FIG. 15 shows a result obtained by recovering the used saw blades the life of which is expired from the users selected in the shape steel market in random and searching the state of the tooth breaking. In this case, a small breaking corresponding to the chipping is excepted, and only a great tooth breaking which is considered that it is completely impossible to cut is counted. As will be understood from the result, among 48 of the searched number, only in 8 blades, the great tooth breaking is not generated, and actually in 83% of the saw blades, the great tooth breaking is generated.

More particularly, in a step of the search, it is apparent that in half and more of the saw blades generating the tooth breaking, the tooth breaking is continuously generated.

As mentioned above, in the shape steel market, there is a great problem that deterioration of the cutting surface and deviation of cutting according to deviation of a saw blade from the cutting line desired and predetermined are generated due to the tooth breaking and the chipping, so that the life of the saw blade is expired.

Next, with reference to FIG. 14, a mechanism of the continuous tooth breaking will be described. Accordingly, there is considered that the case the tooth breaking (a hatching portion shown in the tip of the saw tooth B in FIG. 14) is generated in a saw tooth B due to some reasons when a band saw blade BS is moved to a running direction V as shown in an arrow and a cutting is applied to a cutting direction C as shown in an arrow so that during cutting a work W, a tip line T1 in the band saw blade BS reaches T2. In this case, the band saw blade BS cuts in a state where the band saw blade BS is bent by receiving a thrust force of the cutting, the bending is immediately reduced from the tip line T2 to the tip line T3.

Accordingly, a grain depth of cut of the following saw tooth A becomes X and rapidly becomes great in comparison with a normal grain depth of cut. Accordingly, since the cutting resistance of the saw tooth A rapidly becomes great, the saw tooth A can not resist against this, so that the tooth breaking is generated. When the continuous tooth breaking is generated in the above manner, the tooth breaking tends to be generated in the following saw tooth one by one.

In this case, in GB Patent Unexamined Publication No. 2,009,670 as a prior art example, an example in which a projecting portion is provided at the rear of the tip is shown as a saw blade for cutting a wood, however, a main purpose thereof is that the projecting portion provided at the rear of the tip serves as a guide tooth by inserting into a groove cut by the tip, thereby aiming an improvement of a linearity. In this method, the effect can be obtained only in the case that the grain depth of cut for a tooth is set to be at least equal to or greater than a difference in level between the tip and the projecting portion provided at the rear of the tip.

Generally speaking, a great difference is present in the grain depth of cut for a tooth between a cutting of a wood and a cutting of a metal, and far greater grain depth of cut is given to the case of cutting the wood. Accordingly, the prior example mentioned above is applied to the saw cutting having very great grain depth of cut for a tooth such as the cutting of the wood and the like, and it is conclusively different from the saw blade for cutting the metal. Further, in the prior example mentioned above, a main object is to improve a linearity, however, in view that the object is not to provide a method of continuously preventing a tooth breaking, which corresponds to an object of the present invention, there is a conclusive difference.

### SUMMARY OF THE INVENTION

The present invention has been achieved with such points in mind.

It therefore is an object of the present invention to provide a method of preventing tooth from continuously breaking in a band saw blade a saw tooth structure of the band saw blade used for the method and a band saw blade with a tooth having the same saw tooth.

To achieve the object, according to a first aspect of the present invention, there is provided a method of preventing a tooth from continuously breaking in a band saw blade, comprising the steps of: moving the band saw blade to a longitudinal direction and moving the band saw blade to a cutting direction perpendicular to the moving direction of the band saw blade so as to cut a work; bringing a projecting portion disposed at a rear position of a surface of relief at the back of a tip in a saw tooth broken into contact with a bottom portion of a cutting groove in the work when the tooth breaking is generated in the saw tooth of the band saw blade; and limiting a cutting amount of the following saw tooth, thereby preventing the following saw tooth from breaking.

In the structure mentioned above, in accordance with a deflection generated in the band saw blade at a time of cutting, the band saw blade is going to suddenly return in a linear manner due to a tooth breaking in the saw tooth, however, the projecting portion provided at the rear of the tip of the saw tooth is brought into contact with the bottom portion of the cutting groove in the work, thereby limiting the return amount.

Accordingly, the following saw tooth is restricted a sudden increase of a cutting resistance in the following saw tooth is prevented, so that a continuous tooth breaking of the following saw tooth can be prevented. Accordingly, a life of the band saw blade can be widely improved, and a reduction of a cutting cost can be intended.

According to a second aspect of the present invention, there is provided a saw tooth structure in a band saw blade, comprising: a saw tooth; and a projecting portion disposed at a rear end position of a surface of relief in the saw tooth and having a height lower than a projecting height of the saw tooth.

In accordance with the structure mentioned above, even in the case that the tooth breaking is generated in the saw tooth constituting the band saw blade for cutting the work, a projecting portion disposed at the rear of the tip is brought into contact with the bottom portion of the cutting groove in the work.

Accordingly, a sudden reduction of the deflection generated in the band saw blade at a time of cutting can be prevented, and an application of an excessive cutting resistance to the saw tooth following to the saw tooth generating the tooth breaking can be restricted, so that a continuous tooth breaking can be prevented.

According to a third aspect of the present invention, there is provided a saw tooth structure in a band saw blade comprising: a saw tooth; and a projecting portion disposed in a surface of relief provided at the rear of a tip of the saw tooth, the projecting portion projecting from the surface of relief to a cutting direction of the band saw blade against the work, wherein a distance between an apex of the projecting portion to a direction closest to the cutting direction at the rear of the moving direction of the band saw blade in the projecting portion and a tip of the saw tooth having the projecting portion is within ⅔ of an interval between the saw tooth having the projecting portion and the following saw tooth disposed adjacent to the rear portion of the saw tooth; and a difference in height between the apex and the tip is within a range between 0.05 mm and 1.0 mm.

In accordance with the structure mentioned above, the deflection amount by which the band saw blade linearly returns at a time of generating the tooth breaking can be restricted by that the projecting portion is brought into contact with the bottom portion of the cutting groove in the work.

Accordingly, since an application of an excessive cutting resistance to the following saw tooth can be restricted, a continuous tooth breaking can be prevented.

According to a fourth aspect of the present invention, as it depends from the second or the third aspect, the saw tooth is a dovetail-set tooth.

In accordance with the structure mentioned above, since the saw tooth in the band saw blade is set to be a dovetail-set tooth, a lateral oscillation of the saw tooth in the band saw blade can be reduced.

Accordingly, a roughness in a cutting surface is excellent and a continuous tooth breaking can be prevented.

According to a fifth aspect of the present invention, as it depends from one aspect among the second aspect to the fourth aspect, an angle of relief in the surface of relief is within a range between 15 degrees and 45 degrees.

Accordingly, a rigidity and a cutting performance of the saw tooth will become within a suitable range by setting the angle of relief in the saw tooth to be within a constant range between 15 degrees and 45 degrees.

According to a sixth aspect of the present invention, as it depends from one aspect among the second aspect to the fifth aspect, there is provided a band saw blade for continuously cutting a work by means of a plurality of saw teeth, in which at least suitable number of saw teeth among the plurality of saw teeth have the saw tooth structure as recited, in any one of the second to fifth aspects.

In the structure mentioned above, without limiting the case of having the projecting portion and the projecting portion described in the first aspect to the fifth aspect with respect to all the saw teeth constituting the band saw blade, even in the case of partly having the projecting portion and the projecting portion, the same effect as that of the first to fifth aspects can be obtained.

Accordingly, a continuous tooth breaking can be prevented.

According to a seventh aspect of the present invention, as it depends from the sixth aspect, at least one of a tip line of the plurality of saw teeth and a saw blade back surface is changed in such a manner as to vertically undulate.

Accordingly, a resonance at a time of cutting can be restricted so as to reduce a noise and a vibration, and a further effect that a cutting length can be shortened can be obtained in the case of providing an undulation in the back surface of the saw blade.

In the invention described in any one of the aspects mentioned above, the continuous tooth breaking in the saw tooth can be prevented by making the angle of relief or the front rake small without increasing the cutting resistance which is different from the conventional method of increasing the tip strength, so that the life of the band saw blade can be widely improved without reducing the cutting speed, thereby intending a reduction of the cutting cost.

According to an eighth aspect of the present invention, as it depends from the sixth or the seventh aspect, the band saw blade includes a large right-set tooth and a large left-set tooth, a small right-set tooth, a small left-set teeth, and an unset tooth; and the large right-set tooth and the large left-set tooth have a larger setting amount than that of the small right-set tooth and the small left-set tooth.

According to the construction described above, the groove formed on the work to be cut by the band saw blade is able to keep the necessary width where the band saw blade is smoothly moved in the groove, even when the groove formed on the work is decreased by the internal stress and residual stress in the work which are previously resided in the work to be cut. Furthermore, the scrap which is cut off from the work to be cut by the band saw blade can be shortened.

### BRIEF DESCRIPTION OF THE ACCOMPANYING DRAWINGS

The above and further objects and novel features of the present invention will more fully appear from the following detailed description when the same is read in conjunction with the accompanying drawings, in which:

FIGS. 1A and 1B are a front elevational view and a bottom elevational view which show a basic idea for preventing a continuous tooth breaking of a saw tooth;

FIGS. 2A and 2B are a front elevational view and a bottom elevational view which show an embodiment of a saw tooth and an embodiment of a band saw blade for preventing a continuous tooth breaking of a saw tooth;

FIGS. 3A and 3B are a front elevational view and a bottom elevational view which show another embodiment of a saw tooth and another embodiment of a band saw blade for preventing a continuous tooth breaking of a saw tooth;

FIGS. 4A and 4B are a front elevational view and a bottom elevational view which show the other embodiment of a saw tooth and the other embodiment of a band saw blade for preventing a continuous tooth breaking of a saw tooth;

FIGS. 5A and 5B are a front elevational view and a bottom elevational view which show the other embodiment of a saw tooth and the other embodiment of a band saw blade for preventing a continuous tooth breaking of a saw tooth;

FIGS. 6A and 6B are a front elevational view and a bottom elevational view which show the other embodiment of a saw tooth and the other embodiment of a band saw blade for preventing a continuous tooth breaking of a saw tooth;

FIGS. 7A and 7B are a front elevational view and a bottom elevational view which show the other embodiment of a band saw blade and the other embodiment of a band saw blade for preventing a continuous tooth breaking of a saw tooth;

FIGS. 8A and 8B are a front elevational view and a bottom elevational view which show the embodiment of a saw tooth for preventing a continuous tooth breaking of a saw tooth;

FIGS. 9A, 9B and 9C are a front elevational view, a bottom elevational view and a cross sectional view which show the other embodiment of a saw tooth and the other embodiment of a band saw blade for preventing a continuous tooth breaking of a saw tooth;

FIG. 10 is a front elevational view which shows the other embodiment of a band saw blade for preventing a continuous tooth breaking of a saw tooth;

FIGS. 11A, 11B and 11C are schematic views showing a structure in which a slit is provided in a center portion in a thickness direction of a dovetail/set tooth in the saw blade having the structure shown in FIGS. 9A, 9B and 9C;

FIGS. 12A, 12B, 12C and 12D are schematic views which show a variety of modified embodiments of the saw tooth;

FIGS. 13A and 13B are a front elevational view and a bottom elevational view of the band saw blade according to the present invention where the band saw blade includes a large right-set tooth and a large left-set tooth, a small right-set tooth, a small left-set teeth, and an unset tooth;

FIG. 14 is a schematic view which shows a mechanism for generating a continuous tooth breaking of the saw tooth; and

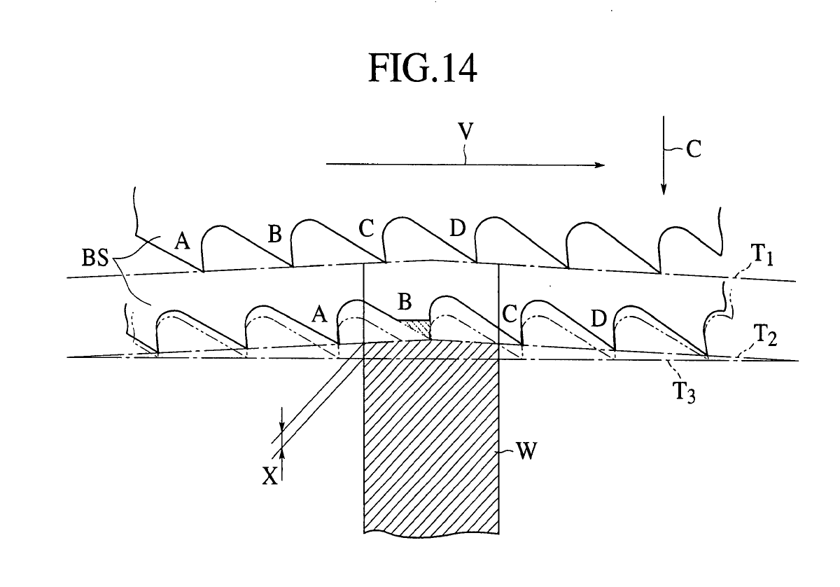

FIG. 15 is a graph which shows a search result with respect to a tooth breaking state in a shape steel market.

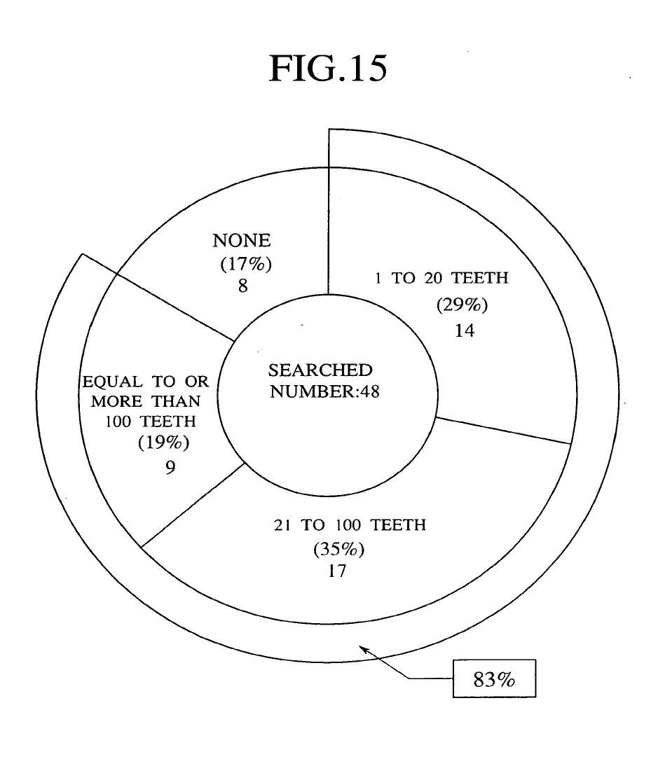

### DETAILED DESCRIPTION OF THE PREFERRED EMBODIMENTS

There will be detailed below the preferred embodiments of the present invention with reference to the accompanying drawings. Like members are designated by like reference characters.

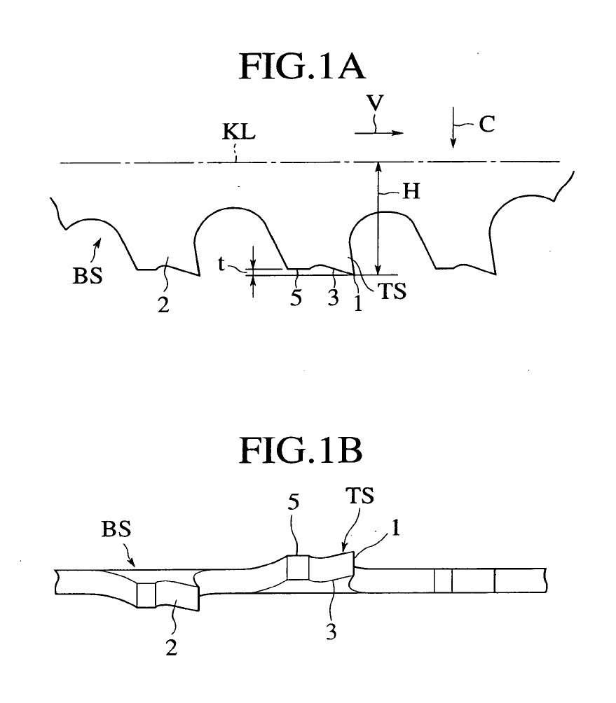

In FIGS. 1A and 1B, a basic idea with respect to a method of continuously preventing a tooth breaking in a band saw blade BS in accordance with the present invention, a structure of a saw tooth TS of a band saw blade BS used for the preventing method and the band saw blade BS are shown. Accordingly, a projecting portion 5 corresponding to a projecting portion as a tooth breaking protector in which a gullet height H corresponding to a distance from a reference line KL a height t lower than the tip 1 is disposed on a surface 3 of relief of a tip 1 in the saw tooth TS, or at a suitable position such as a rear position and the like of the surface 3 of relief.

The projecting portion 5 is not brought into contact with the bottom portion of the cutting groove in the cutting portion in a work W at a time of normal cutting, however, in the case of generating the tooth breaking in the tip 1 by any chance, the contact surface of the projecting portion 5 is brought into contact with the bottom portion of the cutting groove in the cutting portion of the work W, thereby limiting a return amount of a deflection due to a thrust force in the cutting resistance to a height t. Accordingly, a grain depth of cut of the following tooth 2 to a cutting direction C perpendicular to a moving direction V of the band saw blade BS is limited. Therefore, it can be prevented that a grain depth of cut of the following tooth 2 suddenly becomes great and a sudden increase of the cutting resistance can be restricted, so that a continuous generation of the tooth breaking can be prevented.

A concrete embodiment of the structure of the saw tooth TS and the band saw blade BS will be described below.

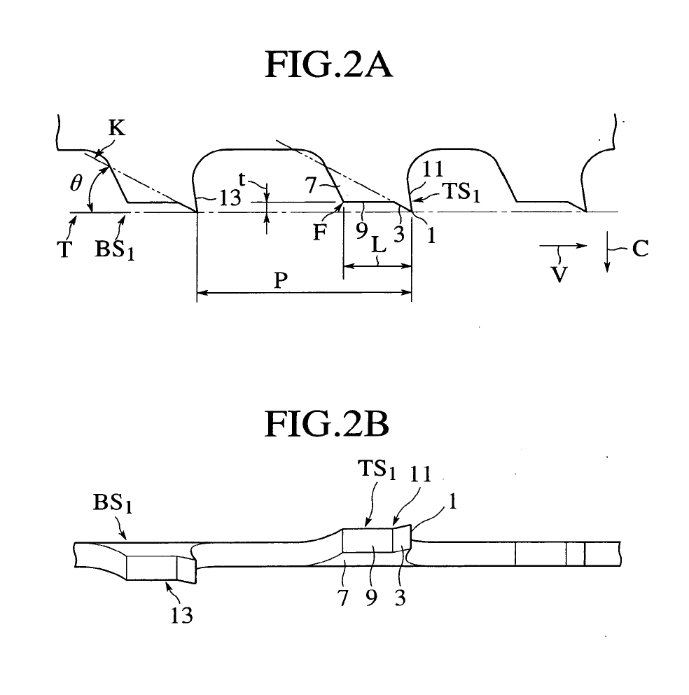

In the saw tooth TS1 of the band saw blade BS1 exemplified in FIGS. 2A and 2B, a projecting portion 7 structured such as to project downward in FIG. 2A in such a manner as to form a triangular shape from an imaginary line K extending rearward (a leftward direction in FIG. 2) of the band saw blade BS on the surface 3 of relief of the tip 1 with keeping an angle θ of relief is provided at the rear (a left portion in FIG. 2A) of the tip 1 as serving as the projecting portion. A contact surface 9 forming the projecting portion 7 is provided in such a manner as to be in parallel to the tip line T as a planar surface portion.

A distance between an apex F positioned at the rearmost portion of the projecting portion 7 as seen from a moving direction V of the band saw blade BS1 and the tip 1 is set to be within ⅔ a saw-tooth pitch P of adjacent teeth 11 and 13. Accordingly, when the distance L mentioned above is too great, a volume of a gullet housing chips becomes small. Accordingly, it is not desirable. Further, in the case that a difference t in height between the tip 1 and the apex F of the projecting portion 7 is within a range of 0.05 to 1.0 mm, that is, in the case that the difference t in height is equal to or less than 0.05 mm, the life reduction due to the tip abrasion is caused, and further, when it becomes a level equal to or more than 1.0 mm, a grain depth of cut in the following tooth is easily increased at a time of generating a tooth breaking, so that a continuous tooth breaking is easily generated. Accordingly, it is not desired. Therefore, it is preferable to constitute in such a manner that the difference t in height becomes 0.15 to 0.40 mm.

Further, the angle θ of relief is set to be within a range of 15 degrees to 45 degrees in embodiments described below in the same manner, and particularly, an angle of 25 degrees to 35 degrees is preferable. Accordingly, when the angle θ of relief becomes a level equal to or more than 45 degrees, a cutting performance with respect to the work is improved, however, the tip becomes an acute angle, so that a rigidity is lowered and an abrasion is easily promoted. Further, when the angle θ of relief becomes a level equal to or less than 15 degrees, the rigidity is improved, however, the cutting performance is easily lowered, so that the angle θ of relief is preferably set to be 15 to 40 degrees, and further, with taking the rigidity of the tip and the cutting performance with respect to the work and the like into consideration, an angle of 25 to 35 degrees is desirable. The band saw blade BS1 is constituted by using the saw tooth TS1 of this kind.

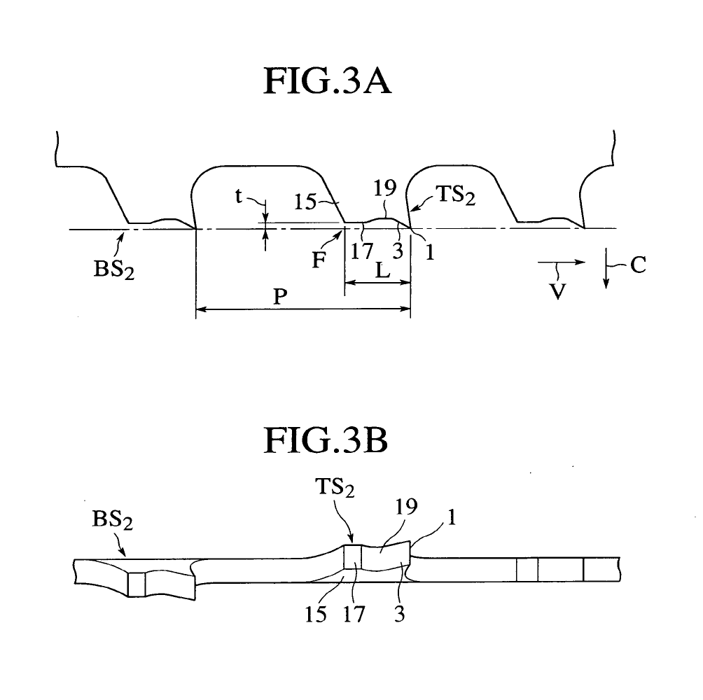

A saw tooth TS2 of a band saw blade BS2 exemplified in FIGS. 3A and 3B is constituted by forming a recess portion 19 on a part of the contact surface 17 of the projecting portion 15 corresponding to the projecting portion in such a manner as to continue the surface 3 of relief.

In this case, a relation between a saw-tooth pitch P and a size L of the projecting portion 15 (having the same meaning as the distance L between the apex F and the tip 1) and a relation of a difference t in height between the tip 1 and the apex F of the projecting portion 15 and the like are the same as the case of the saw tooth TS1 shown in FIG. 2 mentioned above. The band saw blade BS2 is constituted by using the saw tooth TS2 of this kind.

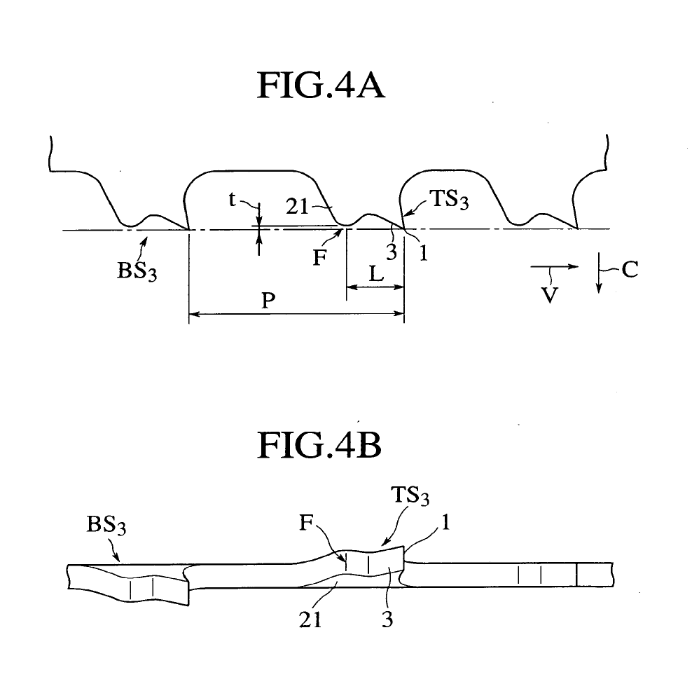

In a projecting portion 21 in a saw tooth TS3 of a band saw blade BS3 exemplified in FIGS. 4A and 4B, the contact surface is not formed in a planner surface shape as the projecting portion 7 corresponding to the projecting portion in the saw tooth TS1 in FIG. 2 mentioned above, but the whole structure of the contact surface not including a definite planner surface portion is formed in a partially circular arc shape or an optionally curved surface.

In this case, a relation between a saw-tooth pitch P and a size L of the projecting portion 21 and a relation of a difference t in height between the tip 1 and the apex F of the projecting portion 21 and the like are the same as the case of the saw tooth TS1 shown in FIG. 2 mentioned above. The band saw blade BS3 is constituted by using the saw tooth TS3 of this kind.

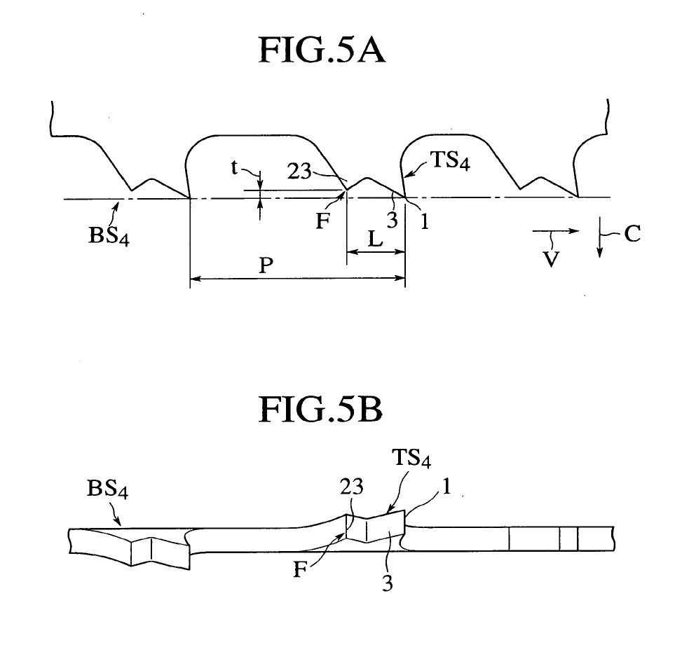

In a projecting portion 23 in a saw tooth TS4 of a band saw blade BS4 exemplified in FIGS. 5A and 5B, the planner surface portion in parallel to the tip line T is not formed as the projecting portion 9 forming the projecting portion 7 corresponding to the projecting portion in the saw tooth TS1 in FIG. 2 mentioned above, but the angle of the apex F becomes an acute angle by constricted the front and rear portion of the apex F of the projecting portion 23.

In this case, a relation between a saw-tooth pitch P and a size L of the projecting portion 23 and a relation of a difference t in height between the tip 1 and the apex F of the projecting portion 23 and the like are the same as the case of the saw tooth TS1 shown in FIG. 2 mentioned above. The band saw blade BS4 is constituted by using the saw tooth TS4 of this kind.

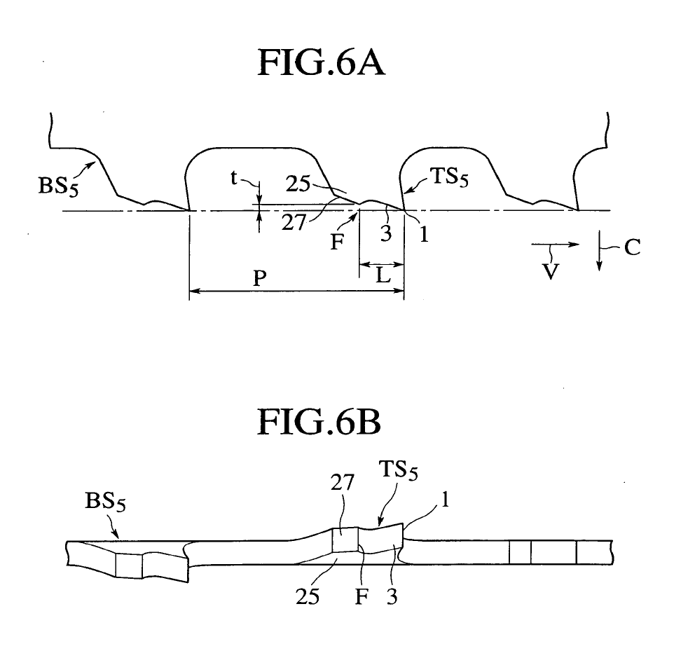

A projecting portion 25 corresponding to a projecting portion in a saw tooth TS5 of a band saw blade BS5 exemplified in FIGS. 6A and 6B has a similar shape to the shape of the projecting portion 23 in the saw tooth TS4 in FIG. 5 mentioned above, but a surface 27 of relief is provided at the rear of the apex F of the projecting portion 25.

In this case, a relation between a saw-tooth pitch P and a size L of the projecting portion 25 and a relation of a difference t in height between the tip 1 and the apex F of the projecting portion 25 and the like are the same as the structure of the saw tooth TS 1 shown in FIG. 2 mentioned above. The band saw blade BS5 is constituted by using the saw tooth TS5 of this kind.

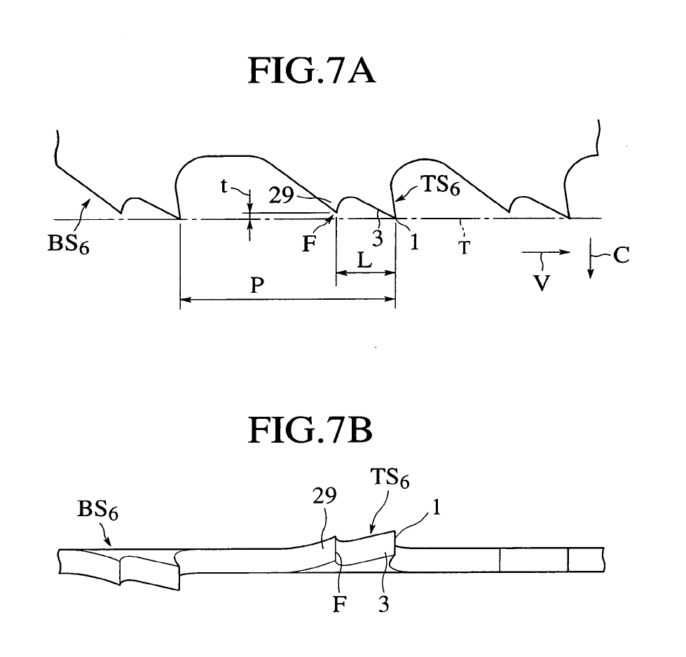

A saw tooth TS6 of a band saw blade BS6 exemplified in FIGS. 7A and 7B has substantially the same shape as that of the tip 1 at the rear of the tip 1 and has a projecting portion 29 corresponding to a projecting portion having a difference t in height with respect to the tip line T at the front end. The front end of the projecting portion 29 is the apex F.

In this case, a relation between a saw-tooth pitch P and a size L of the projecting portion 29 and a relation of a difference t in height between the tip 1 and the apex F of the projecting portion 29 and the like are the same as the structure of the band saw blade BS1 shown in FIG. 2 mentioned above. The band saw blade BS6 is constituted by using the saw tooth TS6 of this kind.

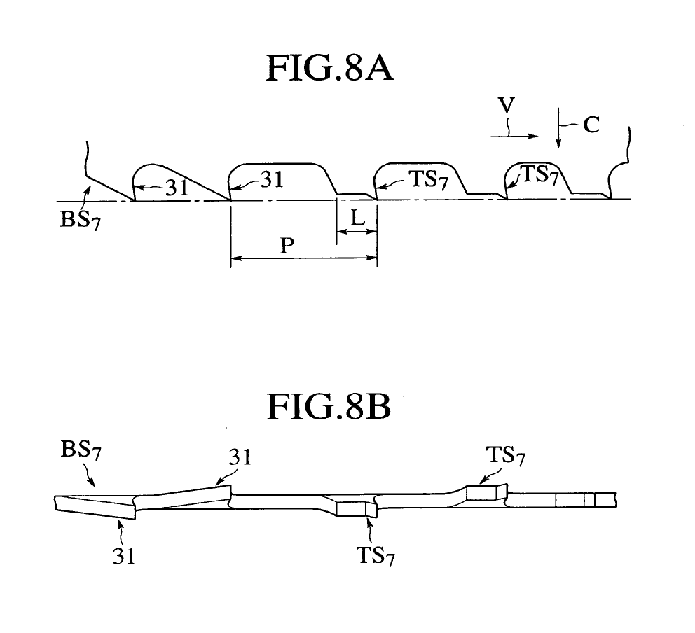

A saw tooth TS7 of a band saw blade BS7 exemplified in FIGS. 8A and 8B has the same shape as that of the saw tooth TS1 shown in FIG. 2 mentioned above. Further, in the band saw blade BS7, a tooth 31 having a normal and popular shape and the saw tooth TS7 mentioned above are mixed. In this case, the saw tooth TS7 may be formed in the other saw tooth shape mentioned above.

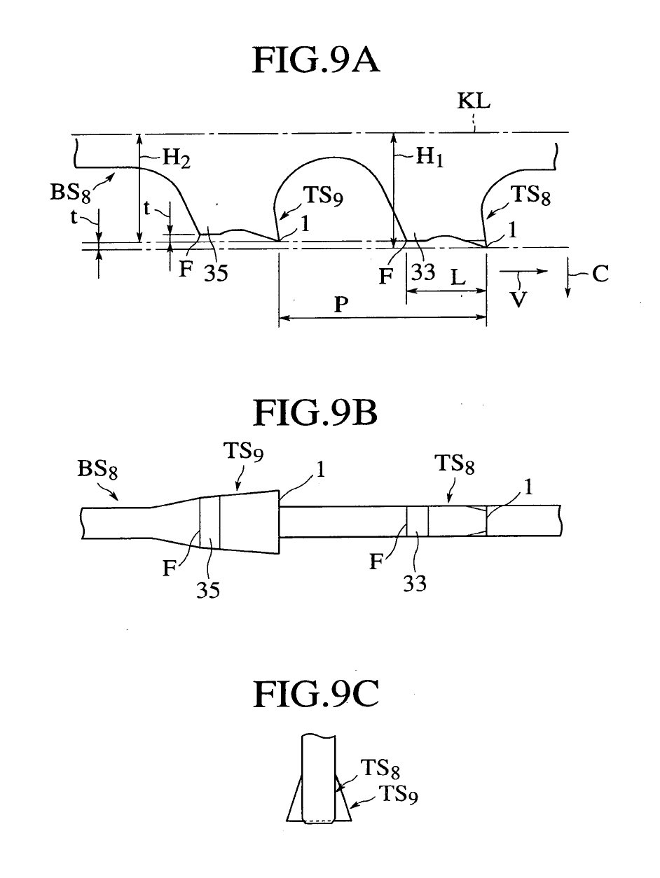

In a saw tooth TS8 of a band saw blade BS8 exemplified in FIGS. 9A, 9B and 9C, a front end of the tip 1 is narrowed and a height of the tooth from the reference line KL is set to be H1, and in a saw tooth TS9, a front end of the tip 1 is widened, a height of the tooth from the reference line KL is set to be H2 and the saw tooth TS9 is formed in a dovetail-set tooth having a height lower than the gullet height H1. Both of the saw teeth TS8 and TS9 have projecting portions 33 and 35 corresponding to a projecting portion having a gullet height from the reference line KL t lower than the tip 1. Further, the band saw blade BS8 is provided with the saw tooth TS8 and the saw tooth TS9 as mentioned above.

In this case, the shape of the projecting portions 33 and 35 in the saw teeth TS8 and TS9 can employ various kinds of shapes as shown in FIGS. 2 to 8. Further, a relation between a saw-tooth pitch P and a size L of the projecting portions 33 and 35 and a relation of a difference t in height between the tip 1 and the apex F of the projecting portions 33 and 35 and the like are the same as the case of the saw tooth TS1 mentioned above.

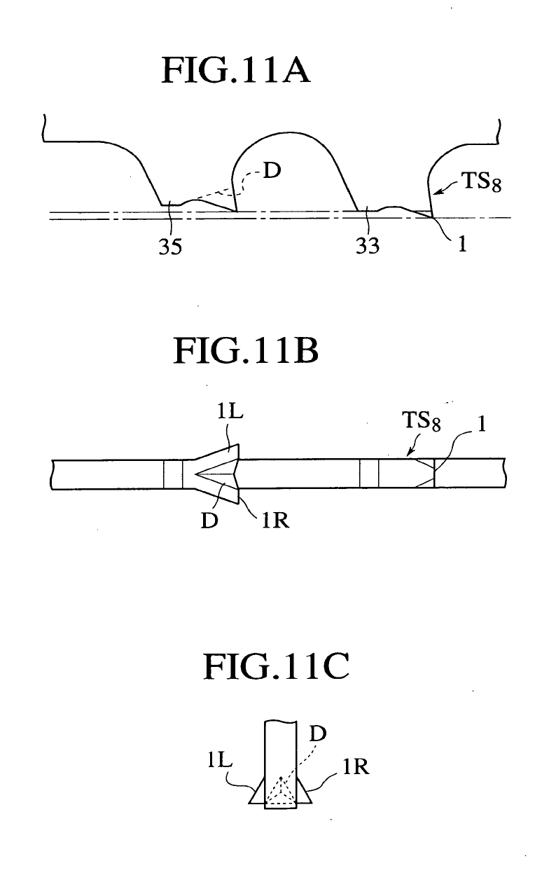

Further, FIG. 11 shows a structure in which a slit D is formed substantially in the center portion of the thickness direction tooth line of the tip in place of the dovetail-set tooth TS9 in FIG. 9 so as to provide with a right-set tooth 1R and a left-set tooth 1L.

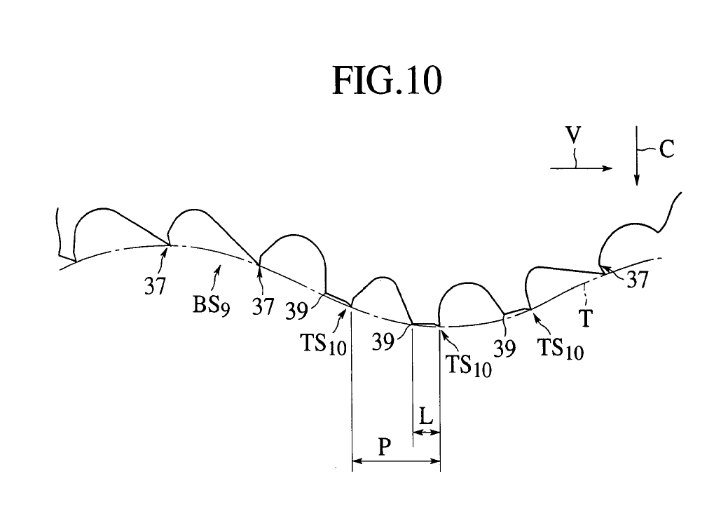

The band saw blade BS9 exemplified in FIG. 10 is structured such that a tip line T at a time of tracing the tip of each of the saw teeth by a smooth curve vertically undulates and changes. The vertical change of the tip line T may be regularly changed or may be irregularly changed. Further, a saw tooth TS10 having a normal saw tooth 37 and a projecting portion 39 corresponding to a projecting portion can be optionally disposed in the band saw blade BS9, however, it is effective to provide the saw tooth TS10 near the top portion of the undulation. As the saw tooth TS10 constituting the band saw blade BS9, any of the saw teeth TS1 to TS9 mentioned above may be employed. Further, in FIG. 10, the embodiment in which the tip line is vertically undulated and changed is shown, however, a band saw blade in which the saw blade back surface or both of the tip line and the back surface is vertically undulated and changed, may be employed. Further, in FIG. 10, the embodiment in which the normal saw tooth 37 and the projecting portion 39 are provided is shown, however, the undulating change mentioned above can be provided in the band saw blade described in any of FIGS. 1 to 9.

In accordance with the structure mentioned above, in the case that the tooth breaking is generated in the saw tooth, since the projecting portion corresponding to the projecting portion disposed in the saw tooth is brought into contact with the bottom portion of the cutting groove for the work W, the deflection of the band saw blade BS at a time of cutting does not return to an extent of a predetermined value, thereby restricting the grain depth of cut of the following saw tooth, so that a continuous generation of the tooth breaking can be prevented by preventing a sudden increase of the cutting resistance in the following saw tooth. Accordingly, the life of the band saw blade BS can be widely improved, and a reduction of a cutting cost can be intended.

In this case, when the distance L is over ⅔ the interval P, the volume of the gullet space becomes small, and a housing amount for the chips becomes small, so that it can not deal with the cutting of the work having a great cutting length. Accordingly, the distance L is preferably set to be a level equal to or less than ⅔ the interval P, and in this case, since the gullet space is not made small, the housing amount for the chips becomes great, so that it can deal with the cutting of the work having a great cutting length.

Further, when the difference t in height between the apex F and the tip 1 is set to be smaller than 0.05 mm, the projecting portion 5 (7, 15, 21, 23, 25, 29, 33, 35) corresponding to the projecting portion is brought into contact with the work W, so that there is a case that the frictional resistance becomes great. When the difference in height becomes more than 1.0 mm, the tooth breaking is easily generated. The difference t in height is preferably desired to be set in a range of 0.15 to 0.40 mm.

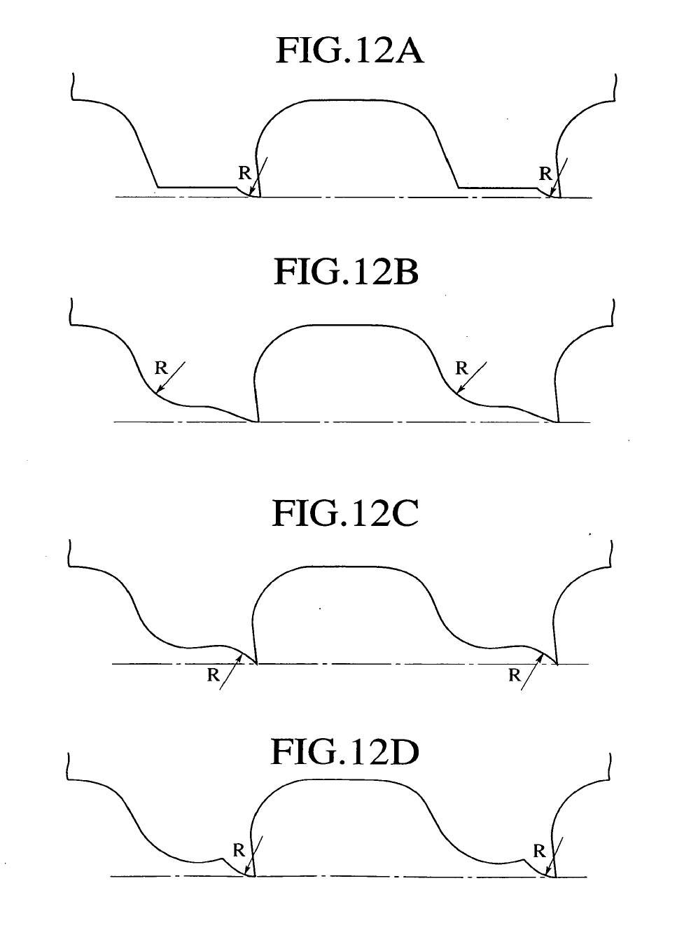

When the angle θ of relief of the surface of relief is less than 15 degrees, the tip strength becomes great, however, the thrust performance becomes small. Further, when the angle of relief is over 45 degrees, the thrust performance becomes great, however, the tip strength becomes small. Accordingly, the angle of relief of the surface of relief is preferably set to be 15 to 45 degrees. In this case, the present invention is not limited to the embodiment mentioned above, and can be performed by the other aspects by suitably forming the surface of relief in a circular arc shape with an unevenness having a radius R or by suitably modifying the projecting portion so as to form in a circular arc shape having a radius R, for example, as shown in FIGS. 12A, 12B, 12C and 12D.

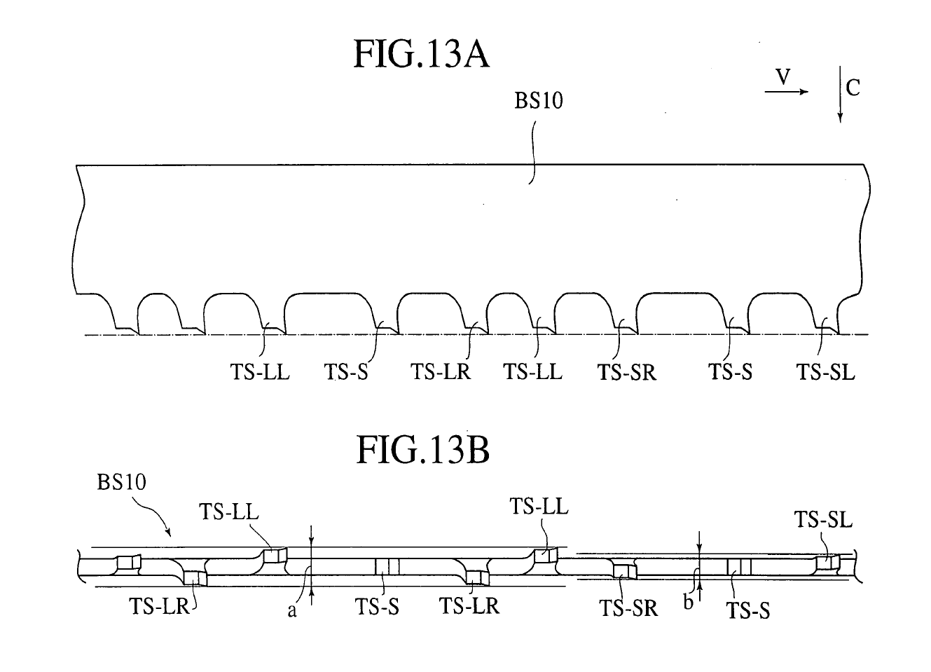

It is desirable that the band saw blades according to the embodiments described above should have a first tooth group including large right-set teeth TS-LR and large left-set teeth TS-LL, and a second tooth group including small right-set teeth TS-SR and small left-set teeth TS-SL as the band saw blade BS10 shown in FIGS. 13A and 13B. Each tooth TS-LR, TS-LL, TS-SR and TS-SL is formed with each projection portion at the rear position of the surface of relief as shown in FIGS. 13A and 13B. The large right-set teeth TS-LR and large left-set teeth TS-LL of the first tooth group have larger setting amount than that of the small right-set teeth TS-SR and small left-set teeth TS-SL of the second tooth group, so that the width of the tooth “a” at the large right-set teeth TS-LR and large left-set teeth TS-LL is larger than the width of the tooth “b” at the small right-set teeth TS-SR and small left-set teeth TS-SL.

According to the construction described above, the groove formed on the work to be cut by the band saw blade BS10 is able to keep the necessary width where the band saw blade BS10 is smoothly moved in the groove, even when the groove formed on the work is decreased by the internal stress and residual stress in the work which are previously resided in the work to be cut. Furthermore, the scrap which is cut off from the work to be cut by the band saw blade can be shortened.

The first tooth group of the band saw blade BS10 shown in FIGS. 13A and 13B includes a pair of the large right-set tooth TS-LR and large left-set tooth TS-LL which are continuously arranged in the series. The arrangement can be changed that the large right-set tooth TS-LR, the small left-set teeth TS-SL, the large left-set tooth TS-LL, the small right-set teeth TS-SR and a straight unset tooth TS-S are continuously and appropriately arranged at random, other than the arrangement shown in FIGS. 13A and 13B.

While preferred embodiments of the present invention have been described using specific terms, such description is for illustrative purposes, and it is to be understood that changes and variations may be made without departing from the spirit or scope of the following claims.

A method of preventing a tooth from continuously breaking in a band saw blade, comprises the steps of: moving the band saw blade to a longitudinal direction and moving the band saw blade to a cutting direction perpendicular to the moving direction of the band saw blade so as to cut a work; bringing a projecting portion disposed at a rear position of a surface of relief at the back of a tip in a saw tooth broken into contact with a bottom portion of a cutting groove in the work when the tooth breaking is generated in the saw tooth of the band saw blade; and limiting a cutting amount of the following saw tooth, thereby preventing the following saw tooth from breaking.

1-8. (canceled)

9. A method of cutting a metal workpiece using a bandsaw blade (BS) having a plurality of saw teeth (TS) provided along a running direction of the bandsaw blade, wherein each of the plurality of saw teeth includes
a tip and
a projecting portion provided at the rear of the tip, and having a contact surface whose height is lower than the height (H) of the tip by a predetermined amount (t),
wherein the plurality of saw teeth includes a first saw tooth and a second saw tooth following the first saw tooth in the running direction of the bandsaw blade,
the method comprising:
causing the bandsaw blade (BS) to cut into a workpiece made of metal while causing the bandsaw blade to run along the running direction, so that the projecting portions of the saw teeth including the first and the second saw teeth are prevented from being in contact with a bottom portion of a cutting groove formed in the workpiece during cutting;
causing the contact surface of the projecting portion of the first tooth to be in contact with the bottom portion of a cutting groove when the tip of the first tooth is broken during cutting, so that the movement of the tip of the second tooth toward the bottom portion of a cutting groove is limited to the predetermined amount (t) between the height of the tip and the height of the contact surface.

10. A method of cutting a metal workpiece using a band saw blade (BS) having a plurality of saw teeth (TS), each saw tooth having a tip and a projecting portion disposed at a rear of the tip, comprising the steps of:
moving the band saw blade (BS) to a longitudinal direction (V) thereof as well as to a cutting direction (C) perpendicular to the longitudinal direction so as to cut the metal workpiece;
bringing, when a tip of a saw tooth is broken, a projecting portion broken into contact with a bottom portion of a cutting groove formed in the metal workpiece; and
limiting a cutting amount of the following saw tooth, thereby preventing the following saw tooth from breaking.

11. The method of claim 10, wherein none of the projecting portion is adapted to perform cutting operation.

12. The method of claim 10, wherein the projecting portion is prevented from being in contact with a bottom portion of a cutting groove during normal cutting operation where no tip of the saw tooth is broken.

13. The method of claim 11, wherein the projecting portion has a shape of triangular, one side of which is defined by a line (K) extending from a rear surface of the tip toward a gullet of the bandsaw blade.

14. The method of claim 13, wherein the projecting portion has a contact surface whose length is less than ⅔ of an interval of the teeth (TS).

15. The method of claim 13, wherein a relief angle of the tip of the tooth is within the range of 25 degree to 35 degree.

16. The method of claim 13, wherein the saw teeth of the bandsaw blade include a straight unset tooth, a pair of large set tooth, and a pair of small set teeth.

17. The method of claim 10, wherein the projecting portion has a contact surface whose height is lower than the height (H) of the tip.

18. A method of cutting a metal workpiece using a bandsaw blade (BS) having a plurality of saw teeth (TS) provided along a running direction of the bandsaw blade, wherein each of the plurality of saw teeth includes
a tip and
a projecting portion provided at the rear of the tip, and having a contact surface whose height is lower than the height (H) of the tip by a predetermined amount (t),
wherein the plurality of saw teeth includes a first saw tooth and a second saw tooth following the first saw tooth in the running direction of the bandsaw blade,
the method comprising:
causing the bandsaw blade (BS) to cut into the metal workpiece while causing the bandsaw blade to run along the running direction, so that the metal workpiece is cut by the tips of the teeth;
causing, when the tip of the first tooth is broken during the cutting, the contact surface of the projecting portion of the first tooth to be in contact with the bottom portion of a cutting groove formed in the metal workpiece;
limiting the movement of the tip of the second tooth toward the bottom portion of a cutting groove to the predetermined amount (t).

19. The method of claim 18, wherein the projecting portions of the saw teeth including the first and the second saw teeth are prevented from being in contact with a bottom portion of a cutting groove formed in the workpiece during regular cutting operation where no tip of the saw tooth is broken.

20. A method of cutting a metal workpiece using a bandsaw blade (BS) having a plurality of saw teeth (TS) provided along a running direction of the bandsaw blade, wherein each of the plurality of saw teeth includes
a tip and
a projecting portion provided at the rear of the tip, and having a contact surface whose height is lower than the height (H) of the tip by a predetermined amount (t),
wherein the plurality of saw teeth includes a first saw tooth and a second saw tooth following the first saw tooth in the running direction of the bandsaw blade,
the method comprising:
causing the bandsaw blade (BS) to cut into the metal workpiece while causing the bandsaw blade to run along the running direction, so that the metal workpiece is cut by the tips of the teeth;
causing, when the tip of the first tooth is broken during the cutting, the contact surface of the projecting portion of the first tooth to be in contact with the bottom portion of a cutting groove formed in the metal workpiece, so that the movement of the tip of the second tooth toward the bottom portion of a cutting groove is limited to the predetermined amount (t).

21. The method of claim 18, wherein the projecting portion has a shape of triangular, one side of which is defined by a line (K) extending from a rear surface of the tip toward a gullet of the bandsaw blade.

22. The method of claim 21, wherein the projecting portion has a contact surface, the length of which is less than ⅔ of an interval of the teeth (TS).

23. The method of claim 21, wherein a relief angle of the tip of the tooth is within the range of 25 degree to 35 degree.

24. The method of claim 21, wherein the saw teeth of the bandsaw blade include a straight unset tooth, a pair of large set tooth, and a pair of small set teeth.
